(19) United States
(12) Patent Application Publication
(10) Pub. No.: US 2001/0007840 A1
(43) Pub. Date: Jul. 12, 2001

(54) Closed hydraulic tensioner

(76) Inventor: Katsuya Nakakubo, Osaka-shi (JP)

Correspondence Address: DANN DORFMAN HERRELL & SKILLMAN, SUITE 720, 1601 MARKET STREET, PHILADELPHIA, PA, 19103-2307, US

(21) Appl. No.: 09/758,488

(22) Filed: Jan. 11, 2001

(30) Foreign Application Priority Data
Jan. 12, 2000 (JP) 003817/2000

(51) Int. Cl. F16H 7/08; F16H 7/22

(52) U.S. Cl. 474/110; 474/109; 474/138

(57) ABSTRACT

A closed hydraulic tensioner has a high-pressure chamber, a low-pressure chamber and a reservoir and contains an oil sealed in advance in the high-pressure chamber, the low-pressure chamber and the reservoir. The hydraulic tensioner further has an oil storage chamber disposed above the reservoir for holding therein an oil scattered within a chain case. The oil storage chamber communicates through an orifice with the reservoir. The hydraulic tensioner further has a bypass passage interconnecting the reservoir and the low-pressure chamber.

### BACKGROUND OF THE INVENTION

1. Field of the Invention

The present invention relates to a closed hydraulic tensioner used for applying an appropriate tension to a timing chain of an automobile engine.

2. Description of the Related Art

Hydraulic tensioners used to apply an appropriate tension to a timing chain of an automobile engine include a closed hydraulic tensioner having an oil sealed therein and an open hydraulic tensioner containing an oil supplied from an oil pump of the engine. The latter-mentioned open hydraulic tensioner further includes a direct supply type hydraulic tensioner in which an oil from the oil pump of the engine is supplied from an oil discharge hole in the engine block through a check valve into a pressure chamber, and a reservoir-equipped type hydraulic tensioner in which an oil from the oil pump is supplied from an oil discharge hole in the engine block into the reservoir and thence to a pressure chamber via a check valve.

FIG. 4A is a side view illustrating one example of the conventional reservoir-equipped hydraulic tensioner mounted to an engine block, and FIG. 4B is a front cross-sectional view of the hydraulic tensioner. As shown in these figures, the reservoir-equipped hydraulic tensioner 1 includes a housing 2 having formed therein an upwardly open reservoir 3 and a plunger accommodating hole 4 (FIG. 4B) extending in a horizontal direction with respect to the reservoir 3. A hollow plunger 5 having an open inner end is slidably inserted into the plunger accommodating hole 4 and resiliently urged by a spring 6 in a direction to project from the housing 2. An outer end of the hollow plunger 5 has an orifice 7. A check valve 8 is provided at the bottom of the plunger accommodating hole 4. The plunger accommodating hole 4 and the hollow plunger 5 jointly form a pressure chamber 9. The reservoir 3 and the check valve 8 communicate with each other via an oil passage 10. The reservoir 3 and the pressure chamber 9 communicate with each other via a second orifice 11. An open end of the reservoir 3 is closed by a plug 12. With this arrangement, an oil from an oil pump (not shown) of an engine is supplied from an oil path 13A in an engine block 13 through an oil supply hole 3A into the reservoir 3. The oil is subsequently supplied successively through the oil passage 10 and the check valve 8 into the pressure chamber 9.

While the engine is operating, the hollow plunger 5 of the reservoir-equipped hydraulic tensioner 1 is subjected to a force or pressure which is variable with fluttering or beating of a timing chain (not shown). When the varying force is smaller than the biasing force of the spring 6, the hollow plunger 5 is thrust in the projecting direction by the force of the spring 6. This movement of the plunger 5 creates a pressure drop within the pressure chamber 9, which causes the check valve 8 to open, thereby permitting the oil in the reservoir 3 to flow through the check valve 8 into the pressure chamber 9. Alternatively when the spring 6 is yielded by the varying force, the plunger 5 moves backward against the force of the spring 6. Backward movement of the plunger 5 creates a pressure rise within the pressure chamber 9, causing the check valve 8 to close. Thus, the oil inside the pressure chamber 9 is forced to flow back to the reservoir 3 through the orifice 11. In addition, when the plunger 5 is subjected to an impact force, the oil inside the pressure chamber 9 is permitted to leak out through the orifice 7 to the outside of the tensioner 1 to thereby absorb the impact force. During operation of the engine, the oil is continuously supplied through the oil path 13 and the oil supply hole 3A into the reservoir 3 so that the reservoir 3 is always filled with the oil. When the engine is started, the supply of oil to the reservoir 3 is not initiated, so that the hydraulic tensioner 1 operates using the oil remaining inside the reservoir 3.

In the reservoir-equipped hydraulic tensioner 1 shown in FIGS. 4A and 4B, the hydraulic pressure of the engine (oil pump) varies continuously depending on the engine speed, operation of variable valves, temperature and the like condition. Since the oil supplied into the pressure chamber 9 of the hydraulic tensioner 1 is influenced by the change in hydraulic pressure of the engine, the damping characteristic of the hydraulic tensioner 1 is rendered unstable.

There still exists a different type of hydraulic tensioner than the reservoir-equipped tensioner shown in FIGS. 4A and 4B. This type of hydraulic tensioner is suppled with an oil scattered within a chain case. The hydraulic tensioner discharges a great amount of oil and hence requires a great supply of oil. Due to this requirement, a case must be large well enough to collect the scattered oil within the chain case.

In addition, the conventional closed hydraulic tensioner has a problem that the performance characteristics would be deteriorated if the leakage of oil occurs through the outer circumferential surface of a piston rod due to a long period of use. To avoid this problem, an expensive oil seal of high durability must be used to seal the outer circumferential surface of the piston rod.

### SUMMARY OF THE INVENTION

In view of the foregoing problems, an object of the present invention is to provide a closed hydraulic tensioner which is not influenced by the change in hydraulic pressure of an engine, is able to achieve a stable tensioning operation, can obviate the need for an oil passage formed in an engine block, and is able to permit the leakage of oil to some extent.

To achieve the foregoing object, the present invention provides a closed hydraulic tensioner comprising a high-pressure chamber, a low-pressure chamber and a reservoir and containing an oil sealed in advance in the high-pressure chamber, the low-pressure chamber and the reservoir, characterized in that an oil storage chamber is disposed above the reservoir for holding therein an oil scattered within a chain case, the oil storage chamber communicating with the reservoir through an orifice.

In the closed hydraulic tensioner, the reservoir communicates with the low-pressure chamber through a bypass passage.

When a timing chain is tensioned abruptly, a piston rod of the hydraulic tensioner is moved backward against the force of a spring by an impact force applied to the piston rod via a tensioner lever. The backward movement of the piston rod increases the hydraulic pressure within the high-pressure chamber to thereby close a check valve of the hydraulic tensioner. Thus, the oil inside the high-pressure chamber is forced to leak out to the low-pressure chamber through a clearance between the outer circumferential surface of the piston rod and the inner circumferential surface of a hollow cylinder of the tensioner. By a flow resistance produced when the oil flows through the clearance between the piston rod and the cylinder, the impact force applied to the piston rod via the tensioner lever is absorbed. During that time, the oil inside the low-pressure chamber is partially returned through the bypass passage to the reservoir.

When the timing chain becomes loose or slack, the piston rod moves forward in the projecting direction by the force of the spring. The forward movement of the piston rod decreases the hydraulic pressure within the high-pressure chamber, thereby causing the check valve to open. The oil held inside the reservoir is thus permitted to flow through the check valve into the high-pressure chamber. In this instance, with the reduction of oil held inside the reservoir, a corresponding amount of oil is replenished from the oil storage chamber through the orifice into the reservoir.

When the leakage occurs though a sliding surface between the piston rod and an oil seal mounted thereon, the hydraulic pressure inside the tensioner decreases. In this instance, however, the oil held inside the oil storage chamber is replenished through the orifice into the reservoir so as to cancel out the amount of leakage.

### BRIEF DESCRIPTION OF THE DRAWINGS

FIG. 1 is a front sectional view of a closed hydraulic tensioner according to an embodiment of the present invention;

FIG. 2 is a diagrammatical view showing an application of the hydraulic tensioner of FIG. 1;

FIG. 3 is a graph showing the leakage of oil from the hydraulic tensioner shown in FIG. 1;

FIG. 4A is a side view of a conventional reservoir-equipped hydraulic tensioner mounted to an engine block; and

FIG. 4B is a front sectional view of the conventional hydraulic tensioner.

### DETAILED DESCRIPTION OF THE PREFERRED EMBODIMENT

A preferred embodiment of the present invention will be described with reference to the accompanying drawings wherein like reference characters designate like or corresponding parts throughout the several views.

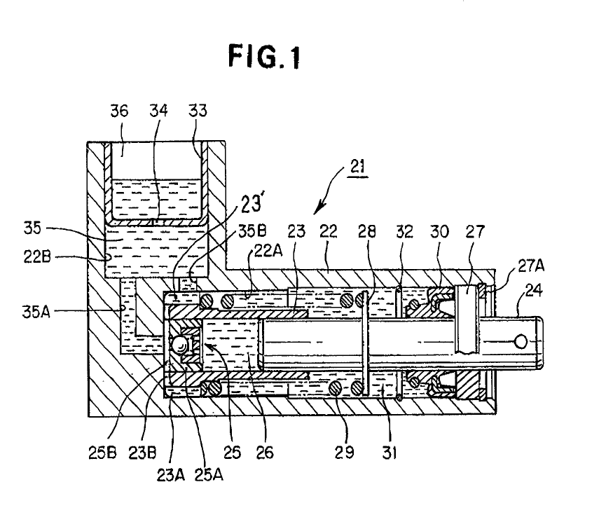

FIG. 1 shows a closed hydraulic tensioner according to an embodiment of the present invention. As shown in this figure, the hydraulic tensioner 21 includes a housing 22, a flanged cylinder 23 mounted in the housing 22, and a piston rod 24 slidably fitted in the flanged cylinder 23 from one end thereof, with a small space or gap defined between the cylinder 23 and the piston rod 24.

A check valve 25 includes a ball seat 25A press-fitted in the other end of the flanged cylinder 23 so that a high-pressure chamber 26 is defined within the flanged cylinder 23. A rod guide 27 is attached by a stop ring 27 to an open end portion of the housing 22 so as to guide movement of the piston rod 24 along the axis of the cylinder 23. An ring-like spring retainer 28 is attached to a longitudinal central portion of the piston rod 24. A compression coil spring 29 is disposed in a pre-loaded or compressed condition between the spring retainer 28 and an annular flange 23′ of the flanged cylinder 23 so that the piston rod 24 is urged by the spring 29 in a direction to project from the housing 22.

The housing 22 is generally L-shaped and has a blind hole 22A extending in a horizontal base of the L-shaped housing 22. The flanged cylinder 23 is disposed in the blind hole 22A with the flange 23′ held in abutment with the bottom of the blind hole 22A. An oil seal 30 is disposed adjacent to the rod guide 27 and acts between an outer circumferential surface of the piston rod 24 and an inner circumferential surface of the blind hole 22A of the housing 22. The piston rod 24, flanged cylinder 23 and housing 22 jointly define therebetween a space 31, and this space 31 forms a low-pressure chamber 31. A second stop ring 32 is attached to the inner circumferential surface of the blind hole 22A and located behind the oil seal 30. The stop ring 32 limits an end of forward movement of the spring retainer 28 as the spring retainer 28 moves together with the piston rod 24.

The flange 23′ of the flanged cylinder 23 has a plurality of axial grooves 23A (two in the illustrated embodiment) formed in an outer peripheral surface thereof. The axial grooves 23A are spaced at equal angular intervals about the axis of the cylinder 23 and form axial oil passages. The flange 23′ further has a plurality of radial grooves 23B (two in the illustrated embodiment) formed in an end face thereof. The radial grooves 23B are spaced at equal angular intervals about the axis of the cylinder 23 and connected at an outer end to the respective axial grooves 23A, the axial grooves 23B forming radial oil passages. The ball seat 25A of the check valve 25 has a radial groove 25B extending diametrically across an end face of the valve seat 25A. The radial groove 25B is connected at opposite ends to the radial grooves (oil passage) 23B of the flange 23′ and forms a second radial oil passage.

The L-shaped housing 22 further has a second blind hole 22B extending in a vertical stem of the L-shaped housing 22. The second blind hole 22B is substantially normal to the blind hole 22A and has an open end facing upward. A cup-shaped oil pan 33 is firmly fitted in the an upper portion of the second blind hole 22B and has an orifice 34 formed in the bottom of the cup-shaped oil pan 33. A lower portion of the second blind hole 22B extending below the cup-shaped oil pan 33 forms a reservoir 35, while the upper portion of the second blind hole 22B extending above the oil pan 33 forms an oil storge chamber 36 for holding therein a scattered oil. The oil storge chamber 36 communicates with the reservoir 35 via the orifice 34.

The bottom of the blind hole 22B is formed with a generally L-shaped oil passage 35A. The L-shaped oil passage 35a communicates with the radial oil passage 25B formed in the end face of the ball seat 25A of the check valve 25. Thus, the reservoir 35 communicates with the low-pressure chamber 31 successively through the L-shaped oil passage 35A in the housing 22, the radial oil passage 25B in the ball seat 25A, and the radial and axial oil passages 23B and 23A in the flange 23′ of the flanged cylinder 23.

The bottom of the blind hole 22B is further formed with a bypass passage 35B connected at one end to the reservoir 35 and at the other end to one of the axial oil passages 23A of the flange 23′ of the flanged cylinder 23. Thus, the reservoir 35 communicates with the low-pressure chamber 31 through the bypass passage 35B and the axial oil passage 23A.

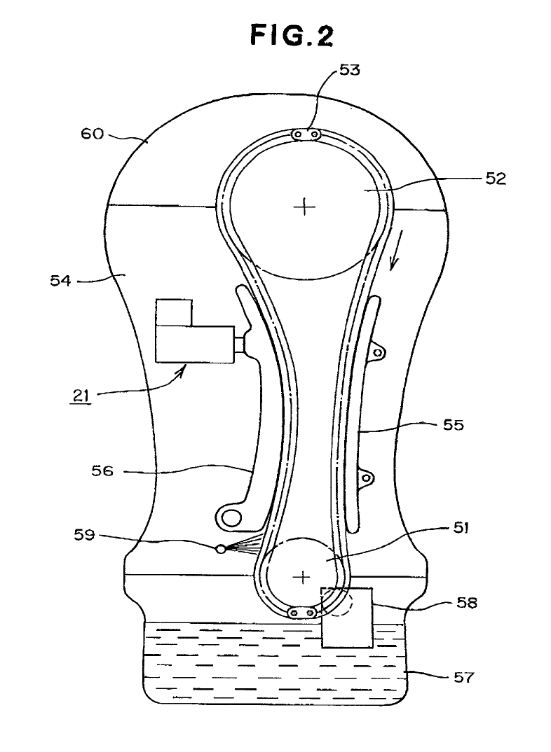

FIG. 2 diagrammatically shows one form of application of the closed hydraulic tensioner 21 shown in FIG. 1. In the application shown in FIG. 2, a chain case of an automobile engine is removed to clarify the positional relationship between the tensioner 21 and related parts thereof. As shown in FIG. 2, crank sprocket 51 and a cam sprocket 52 are connected by a timing chain 53. The timing chain 53 is driven to travel in the direction of the arrow. A chain guide 55 is mounted to an engine block 54 at a tension side of the timing chain 53, and a tensioner lever 56 is pivotally mounted to the engine block 54 at a slack side of the timing chain 53. The closed hydraulic tensioner 21 is mounted to the engine block 54 at the slack side of the timing chain 53 in such a manner that an outer end (projecting end) of the piston rod 24 of the tensioner 21 is in abutment with the rear surface of a free end portion of the tensioner lever 56. An oil pan 57 is disposed below the engine block 54 and holds therein an oil. An oil pump 57 is disposed in the oil pan 57 so that the oil can be sprayed from an oil jet 59 onto the timing chain 53 to thereby lubricate the timing chain 53. As the timing chain 23 travels around the sprockets 51, 52 in the direction of the arrow, the oil adhering to the timing chain 53 is scattered from the chain 53 at a position above the hydraulic tensioner 21. The scattered oil is then collected and stored in the oil storage chamber 36 of the hydraulic tensioner 21. Numeral 60 shown in FIG. 2 denotes a cylinder head of the engine.

The hydraulic tensioner 21 operates as follows.

When the timing chain 53 is tensioned abruptly, the piston rod 24 is moved backward against the force of the spring 29 by an impact force applied to the piston rod 21 via the tensioner lever 56. The backward movement of the piston rod 24 increases the hydraulic pressure within the high-pressure chamber 26, thereby closing the check valve 25. Thus, the oil inside the high-pressure chamber 26 is forced to leak into the low-pressure chamber 31 through a clearance between the outer circumferential surface of the piston rod 24 and the inner circumferential surface of the hollow cylinder 23. By a flow resistance produced when the oil flows through the clearance between the piston rod 24 and the cylinder 23, the impact force applied to the piston rod 24 via the tensioner lever 56 is absorbed. During that time, the oil inside the low-pressure chamber 31 is partially returned through the bypass passage 35B to the reservoir 35.

When the timing chain 53 becomes loose or slack, the piston rod 24 moves forward in the projecting direction by the force of the spring 29. The forward movement of the piston rod 24 decreases the hydraulic pressure within the high-pressure chamber 26, thereby causing the check valve 25 to open. The oil held inside the reservoir 35 is thus permitted to flow through the check valve 25 into the high-pressure chamber 26. In this instance, with the reduction of oil held inside the reservoir 35, a corresponding amount of oil is replenished from the oil storage chamber 36 through the orifice 34 into the reservoir 35.

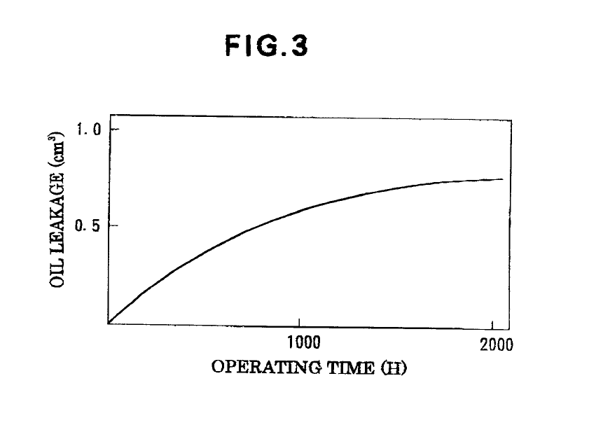

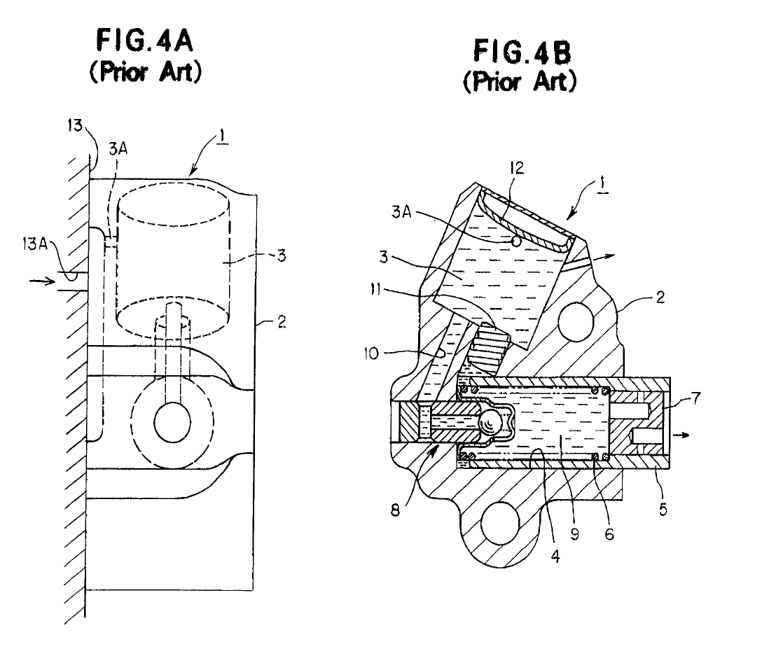

As shown in FIG. 3, a long term operation of the closed hydraulic tensioner 21 is accompanied with the leakage of oil occurring through a sliding surface between the piston rod 24 and the oil seal 30 even though the amount of leakage is very small. When the leakage occurs, the hydraulic pressure inside the tensioner 21 decreases. However, in the illustrated embodiment, the oil held inside the oil storage chamber 36 is replenished through the orifice 34 into the reservoir 35 so as to cancel out the amount of leakage.

According to the embodiment shown in FIG. 1, the oil scattered within the chain case is effectively used in the closed hydraulic tensioner 21. The hydraulic tensioner 21 is, therefore, not influenced by the change in hydraulic pressure of the engine and hence is able to achieve a highly stable tensioning operation. Further, the hydraulic tensioner 21 does not require the engine block to have complicated oil passages and hence achieves a considerable reduction of cost. In addition, the hydraulic tensioner 21 permits the leakage of oil to some extent and hence allows the use of an inexpensive oil seal. Thus, the hydraulic tensioner 21 of the present invention, as against the conventional closed hydraulic tensioner, is free from an oil leakage problem and hence has an improved degree of reliability.

Obviously, various minor changes and modifications of the present invention are possible in the light of the above teaching. It is therefore to be understood that within the scope of the appended claims, the present invention may be practiced otherwise than as specifically described.

What is claimed is:

1. A closed hydraulic tensioner for applying an appropriate tension to a chain disposed within a chain case, said tensioner comprising a high-pressure chamber, a low-pressure chamber and a reservoir and containing an oil sealed in advance in the high-pressure chamber, the low-pressure chamber and the reservoir, the improvement comprising:
an oil storage chamber disposed above the reservoir for holding therein an oil scattered within the chain case, said oil storage chamber communicating with the reservoir through an orifice.

2. A closed hydraulic tensioner according to claim 1, wherein the reservoir communicates with the low-pressure chamber through a bypass passage.

3. A closed hydraulic tensioner for applying an appropriate tension to a chain disposed within a chain case, said tensioner comprising:
a housing having a first blind hole extending in a horizontal direction and a second blind hole extending in a vertical direction, said second blind hole having an open end facing upward;
a cylinder mounted in said first blind hole in said housing;
a piston rod having one end portion slidably fitted in said cylinder with a small clearance defined therebetween and the opposite end portion projecting outward from said housing;
a spring acting between said cylinder and said piston rod to urge said piston rod in one direction to project from said housing;
an oil seal disposed between an outer circumferential surface of said piston rod and an inner circumferential surface of said first blind hole in said housing, there being defined between said housing, said cylinder, said piston rod and said oil seal a low-pressure chamber;
a generally cup-shaped oil pan fitted in said second blind hole and defining, in said second blind hole, an oil storage chamber disposed above said oil pan for holding therein an oil scattered within the chain case and a reservoir disposed below said oil pan for holding therein the oil, said oil pan having an orifice interconnecting said oil storage chamber and said reservoir; and
a check valve provided at one end of said cylinder so as to define, jointly with the cylinder and said one end of said piston rod, a high-pressure chamber, said high-pressure chamber being connected with said reservoir via said check valve, said check valve being operable to permit passage of the oil in one direction from said reservoir to said high-pressure chamber and block passage of the oil in the opposite direction.

4. A closed hydraulic tensioner according to claim 3, wherein said reservoir communicates with said low-pressure chamber through a bypass passage formed in said housing.

5. A closed hydraulic tensioner according to claim 4, wherein said cylinder comprises a flanged cylinder having an annular flange at one end thereof, said annular flange being in abutment with the bottom of said first blind hole and having an axial groove connected at one end with said low-pressure chamber, and a radial groove connected at one end with the other end of said axial groove and at the other end with said reservoir, said bypass passage being connected with said low-pressure chamber via said axial groove in the flange of said cylinder.
